(19) United States
(12) Patent Application Publication
(10) Pub. No.: US 2015/0213497 A1
(43) Pub. Date: Jul. 30, 2015

(54) PEER-BASED GEO-FENCE MESSAGING

(71) Applicants: Chintan Jain, Hillsboro, OR (US); Rui Kong, Lake Oswego, OR (US); Greg Alan Cox, Portland, OR (US)

(72) Inventors: Chintan Jain, Hillsboro, OR (US); Rui Kong, Lake Oswego, OR (US); Greg Alan Cox, Portland, OR (US)

(73) Assignee: EBAY INC., SAN JOSE CALIFORNIA, CA (US)

(21) Appl. No.: 14/167,770

(22) Filed: Jan. 29, 2014

(51) Int. Cl. G06Q 30/02; G06Q 50/00; H04L 29/08; H04W 4/02; H04L 12/58; H04L 12/18

(52) U.S. Cl. CPC G06Q 30/0261; H04L 51/32; H04L 12/1813; H04L 67/22; H04W 4/021; G06Q 50/01

(57) ABSTRACT

A system comprising a computer-readable storage medium storing at least one program and a computer-implemented method for transmitting peer-based geo-fence messages are described. Consistent with some embodiments, the method may include detecting a subject user breaching a geo-fence, and locating proximate users within a predefined distance of the subject user. A peer user of the subject user is then identified from the proximate users. The method may further include transmitting a message to the peer user in response to the subject user breaching the geo-fence.

### TECHNICAL FIELD

This application relates to data processing. In particular, example embodiments may relate to provisioning messages based on geo-fences of peers.

### BACKGROUND

A “geo-fence” is a virtual perimeter created around real-world geographic locations. Traditional geo-fence services often provide geo-fences to merchants or other businesses at the merchant's or business' location. When a user, who has opted into such a service, enters or exits a perimeter of one of these geo-fences with a location-aware device (e.g., a smartphone), a marketing notification may be sent to the user to entice the nearby user to patronize one of these locations. However, the reach and influence of these types of notifications is limited because only a user who enters the geo-fence will receive a notification, and users who are potential customers may be elsewhere. Additionally, as these notifications only entice patronage from users who are likely already intending to patronize such establishments, the capability of these notifications to influence a wider audience is further limited.

### BRIEF DESCRIPTION OF THE DRAWINGS

Various ones of the appended drawings merely illustrate example embodiments of the present invention and cannot be considered as limiting its scope.

FIG. 1 is a network diagram depicting a network system having a client-server architecture configured for exchanging data over a network, according to an example embodiment.

FIG. 2 is an interaction diagram depicting example exchanges between a first client device, an application server, and a second client device, consistent with some embodiments.

FIG. 3A is a diagrammatic representation of an example geo-fence surrounding a real-world location, consistent with some embodiments.

FIG. 3B is a diagrammatic representation of a subject user entering the example geo-fence and a plurality of proximate users, consistent with some embodiments.

FIG. 3C is an interface diagram depicting a message presented on a client device of a user, consistent with some embodiments.

FIG. 4 is a block diagram illustrating an example embodiment of multiple modules forming a peer-based messaging application, which is provided as part of the network system of FIG. 1.

FIG. 5 is a flowchart illustrating an example method for provisioning a peer-based geo-fence message, consistent with some embodiments.

FIG. 6 is a flowchart illustrating an example method for detecting a subject user entering a geo-fence, consistent with some embodiments.

FIG. 7 is a flowchart illustrating an example method for expanding a size of a geo-fence of a peer user, consistent with some embodiments.

FIG. 8 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings. It will be understood that they are not intended to limit the scope of the claims to the described embodiments. On the contrary, they are intended to cover alternatives, modifications, and equivalents as may be included within the scope of the disclosure. In the following description, specific details are set forth in order to provide a thorough understanding of the subject matter. Embodiments may be practiced without some or all of these specific details. In accordance with the present disclosure, components, process steps, and data structures may be implemented using various types of operating systems, programming languages, computing platforms, computer programs, and/or general purpose machines.

Aspects of the present disclosure describe systems and methods for sending messages to users that are peers of a subject user that has entered or exited a geo-fence. For example, when a subject user has entered a geo-fence, an additional user can be targeted for a marketing notification if the additional user is in proximity to the subject user, and there is a relationship between the subject user and the additional user. Consistent with some embodiments, the method may include detecting a subject user entering or exiting a geo-fence. Upon detecting the subject user entering or exiting the geo-fence, the method may include locating additional users that are nearby the subject user (e.g., within a certain distance from the subject user). The method may further include identifying one of the nearby users as a peer of the subject user, and sending a message to the peer users.

Consistent with some embodiments, users are considered “peers” in the sense that they share some sort of relationship, whether direct or indirect. Examples of peer users include, but are not limited to the following: an additional user who is linked or connected on a social network with the subject user, an additional user who is following a subject user using a social network service, an additional user who shares pin boards on Pinterest with the subject user, an additional user who shares common interests or hobbies with the subject user, an additional user who has similar purchase histories as a subject user, an additional user that is a part of the same demographic (e.g., age group, income level, social status, or marital status) as a subject user. The identification of a user as a peer may be based on social data about each of the users (e.g., from social network services such as Facebook®, Twitter®, Foursquare®, or the like), or based on transactional data about electronic marketplace transactions conducted by users (e.g., maintained by electronic marketplaces such as eBay.com®, StubHub®, or the like).

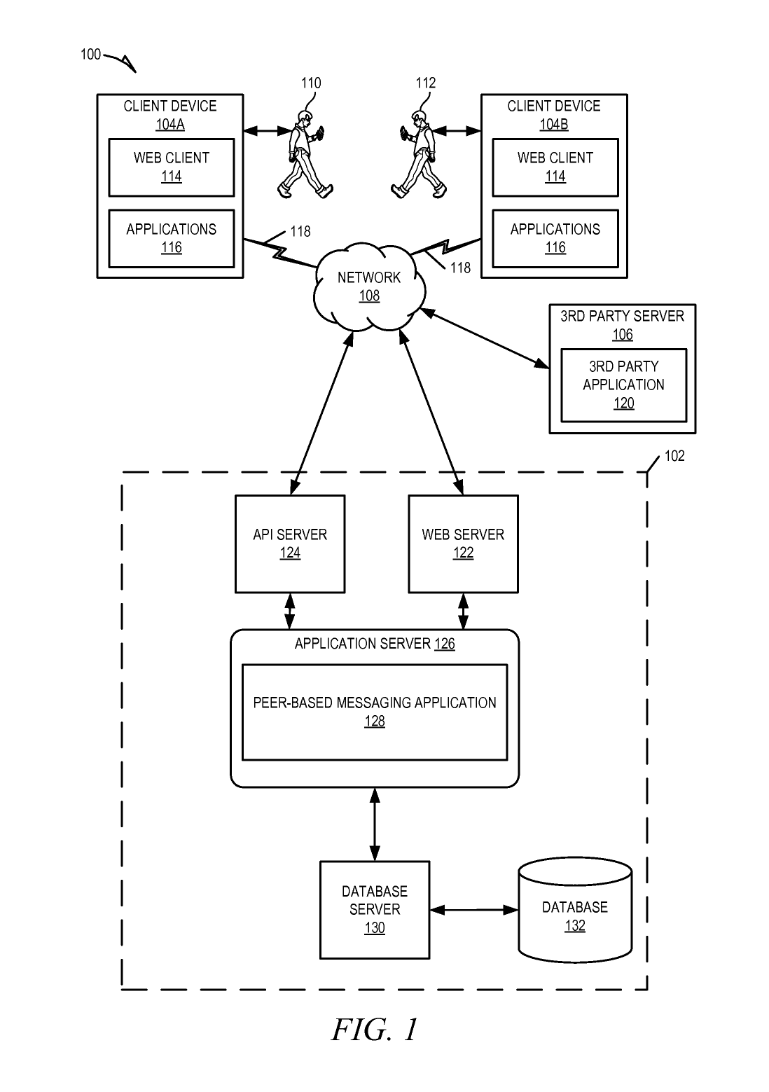

FIG. 1 is a network diagram depicting a network system 100, according to one embodiment, having a client-server architecture configured for exchanging data over a network. The network system 100 may include a network-based content publisher 102 in communication with client devices 104A and 104B and a third party server 106. In some example embodiments, the network-based content publisher 102 may be a network-based marketplace.

The network-based content publisher 102 may communicate and exchange data within the network system 100 that may pertain to various functions and aspects associated with the network system 100 and its users. The network-based content publisher 102 may provide server-side functionality, via a network 108 (e.g., the Internet), to one or more client devices (e.g., client devices 104A and 104B). The client devices 104A and 104B may be operated by a subject user 110 and a peer user 112, respectively. The subject user 110 and peer user 112 represent users that use the network system 100 to exchange data over a network 108. These transactions may include transmitting, receiving (communicating), and processing data to, from, and regarding content and users of the network system 100. The data may include, but are not limited to: images; video or audio content; user preferences; product and service feedback, advice and reviews; product, service, manufacturer, and vendor recommendations and identifiers; product and service listings associated with buyers and sellers; product and service advertisements; auction bids; transaction data; geo-location data; and social data, among other things.

In various embodiments, the data exchanged within the network system 100 may be dependent upon user-selected functions available through one or more client or user interfaces (UIs). The UIs may be associated with a client device (e.g., client device 104A or 104B) using web client 114. The web client 114 may be in communication with the network-based content publisher 102 via a web server 122. The UIs may also be associated with one or more applications 116 executing on the client devices 104A and 104B, such as a client application designed for interacting with the network-based content publisher 102, or the third party server 106 (e.g., one or more servers or client devices) hosting a third party application 120.

The client devices 104A and 104B may be any of a variety of types of devices. For example, the client devices 104A or 104B may be a mobile device such as an iPhone® or other mobile device running the iOS® operating system, an Android® operating system, a BlackBerry® operating system, a Microsoft® Windows® Phone operating system, Symbian® OS, or webOS®. Consistent with some embodiments, the client devices 104A or 104B may alternatively be a tablet computer, such as an iPad® or other tablet computer running one of the aforementioned operating systems. In some embodiments, the client devices 104A or 104B may also be a personal digital assistant (PDA), a personal navigation device (PND), a handheld computer, a desktop computer, a laptop or netbook, a set-top box (STB) such as provided by cable or satellite content providers, a wearable computing device such as glasses or a wristwatch, a multimedia device embedded in an automobile, a global positioning system (GPS) device, a data enabled book reader, or a video game system console such as the Nintendo Wii®, the Microsoft Xbox 360®, the Sony PlayStation 3®, or other video game system consoles.

The client devices 104A and 104B may interface via a connection 118 with the communication network 108 (e.g., the Internet or wide area network (WAN)). Depending on the form of the client devices 104A and 104B, any of a variety of types of connections 118 and communication networks 108 may be used. For example, the connection 118 may be code division multiple access (CDMA) connection, a global system for mobile communications (GSM) connection, or other type of cellular connection. Such a connection 118 may implement any of a variety of types of data transfer technology, such as single carrier radio transmission technology (1xRTT), evolution-data optimized (EVDO) technology, general packet radio service (GPRS) technology, enhanced data rates for GSM evolution (EDGE) technology, or other data transfer technology (e.g., fourth generation wireless, 4G networks). When such technology is employed, the communication network 108 may include a cellular network that has a plurality of cell sites of overlapping geographic coverage, interconnected by cellular telephone exchanges. These cellular telephone exchanges may be coupled to a network backbone (e.g., the public switched telephone network (PSTN), a packet-switched data network, or to other types of networks).

In another example, the connection 118 may be wireless fidelity (Wi-Fi, IEEE 802.11x type) connection, a worldwide interoperability for microwave access (WiMAX) connection, or another type of wireless data connection. In such an embodiment, the communication network 108 may include one or more wireless access points coupled to a local area network (LAN), a WAN, the Internet, or other packet-switched data network. In yet another example, the connection 118 may be a wired connection, for example an Ethernet link, and the communication network 108 may be a LAN, a WAN, the Internet, or other packet-switched data network. Accordingly, a variety of different configurations are expressly contemplated.

FIG. 1 also illustrates the third party application 120 executing on the third party server 106 that may offer one or more services to users of the client device 104A and 104B. The third party application 120 may have programmatic access to the network-based content publisher 102 via the programmatic interface provided by an application program interface (API) server 124. In some embodiments, the third party application 120 may be associated with any organization that may conduct transactions with or provide services to the users of the client device 104A, and 104B. For example, the third party application 120 may be associated with a network based social network service (e.g., Facebook®, Twitter®, Google+®, Pinterest®, LinkedIn®, or the like) that may provide a platform for members to build and maintain social networks and relations among other members. To this end, a social network service may allow members to share ideas, pictures, posts, activities, events, and interests with other members of the social network. The social network service may provide a representation of each member in the form of a social network profile. The social network profile of each member may contain information about the member (hereinafter referred to as “social data”) such as demographic information (e.g., gender, age, etc.), geographic information (e.g., a user's hometown, a user's current location, etc.), interests, a history of social network activity, and social network connections of the members. For purposes of the present disclosure, a social network “connection,” also referred to as being “connected” on a social network, may include situations in which there is a reciprocal agreement between members of the social network to be linked on the social network, as well as situations in which there is only a singular acknowledgement of the “connection” without further action being taken by the other member. In the reciprocal agreement situation, both members of the “connection” acknowledge the establishment of the connection (e.g., friends). Similarly, in the singular acknowledgement situation, a member may elect to “follow” or “watch” another member. In contrast to reciprocal agreement, the concept of “following” another member typically is a unilateral operation because it may not necessitate acknowledgement or approval by the member that is being followed.

Turning specifically to the network-based content publisher 102, the API server 124 and a web server 122 are coupled to, and provide programmatic and web interfaces respectively to, one or more application servers 126. The application server 126 may, for example, host one or more applications, which may provide a number of content publishing and viewing functions and services to users that access the network-based content publisher 102. The application server 126 may further host a plurality of user accounts for users of the network-based content publisher 102, which may be stored in a database 132. Users of the network-based content publisher 102 without a user account may be assigned a globally unique identifier (GUID) so that such users may nonetheless be uniquely identified by the network based content publisher 102.

As illustrated in FIG. 1, the application server 126 may host a peer-based messaging application 128, which may provide geo-fence and notification services to users of the network-based content publisher 102. For example, the peer-based messaging application 128 may generate and assign a geo-fence to a subject user 110, and in response to the subject user 110 breaching the geo-fence, the peer-based messaging application 128 may transmit a message to a proximate user that is a peer of the subject user 110 (also referred to herein as a “peer user”).

As illustrated in FIG. 1, the application server 126 may be coupled via the API server 124 and the web server 122 to the communication network 108, for example, via wired or wireless interfaces. The application server 126 is, in turn, shown to be coupled to a database server 130 that facilitates access to the database 132. In some examples, the application servers 126 can access the database 132 directly without the need for the database server 130. In some embodiments, the database 132 may include multiple databases 132 that may be internal or external to the network-based content publisher 102.

The database 132 may store data pertaining to various functions and aspects associated with the network system 100 and its users. For example, user accounts for users of the network based content publisher 102 may be stored and maintained in the database 132. Each user account may comprise user data that describes aspects of a particular user. The user data may include demographic data, user preferences, financial information and a transaction history. Consistent with some embodiments, the transaction history may include information related to transactions for items or services (collectively referred to as “products”) that may be offered for sale by merchants using marketplace services provided by the network-based content publisher 102. The transaction history information may, for example, include a description of a product purchased by the user, an identifier of the product, a category to which the product belongs, a purchase price, a quantity, or a number of bids.

While the peer-based messaging application 128 is shown in FIG. 1 to form part of the network-based content publisher 102, it will be appreciated that, in alternative embodiments, the peer-based messaging application 128 may form part of a service that is separate and distinct from the network-based content publisher 102. Further, while the system 100 shown in FIG. 1 employs client-server architecture, the present inventive subject matter is, of course, not limited to such an architecture, and could equally well find application in an event-driven, distributed, or peer-to-peer architecture system, for example. The various functional components of the application server 126 may also be implemented as standalone systems or software programs, which do not necessarily have networking capabilities. It shall be appreciated that although the various functional components of the network system 100 are discussed in the singular sense, multiple instances of one or more of the various functional components may be employed.

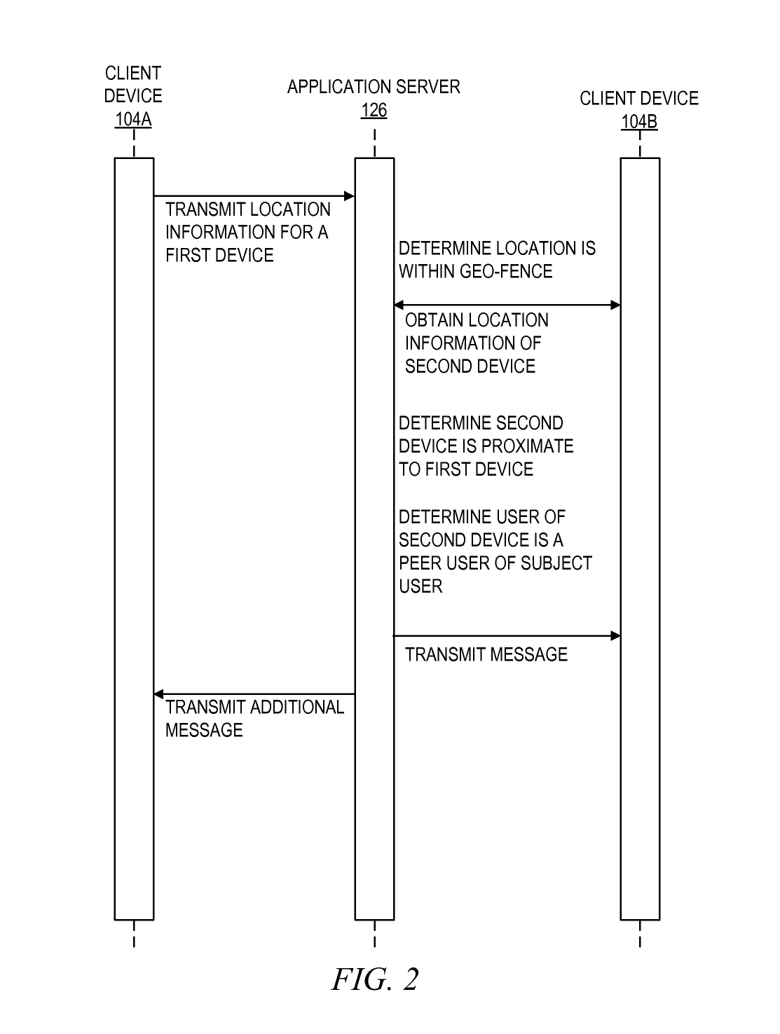

FIG. 2 is an interaction diagram depicting example exchanges between a first client device, an application server, and a second client device, consistent with some embodiments. In particular, FIG. 2 depicts exchanges between the client device 104A, the application server 126, and the client device 104B in the context of provisioning peer-based geo-fence notifications. The subject user 110 may be operating the client device 104A and may have a corresponding geo-fence surrounding a virtual location.

As shown, the client device 104A (e.g., a “first device”) transmits location information (e.g., the location of the client device 104A) to the application server 126. The client device 104A, as well as the client device 104B, may be in constant communication with the application server 126 to provide the location of the client device 104A, which consequently is the location of the subject user 110, to the application server 126.

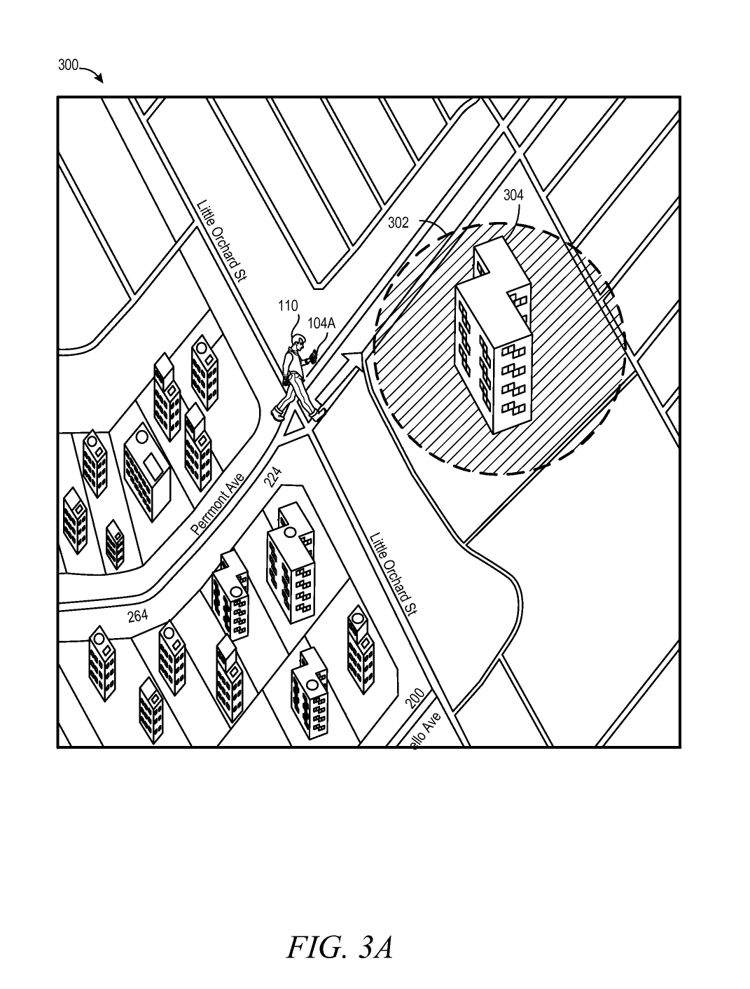

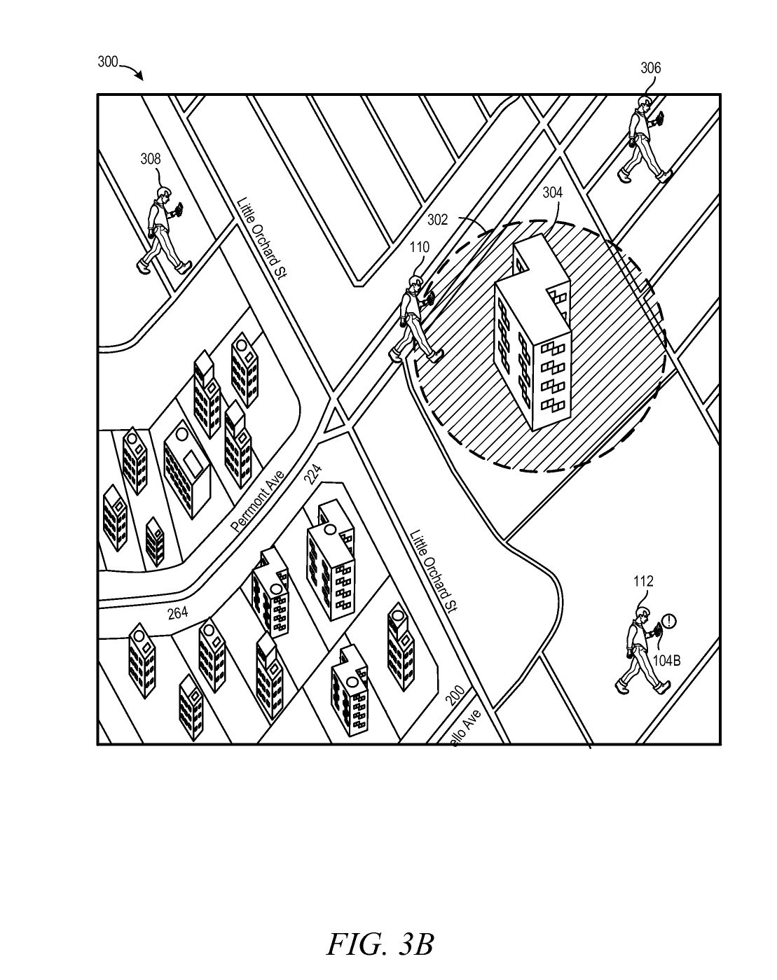

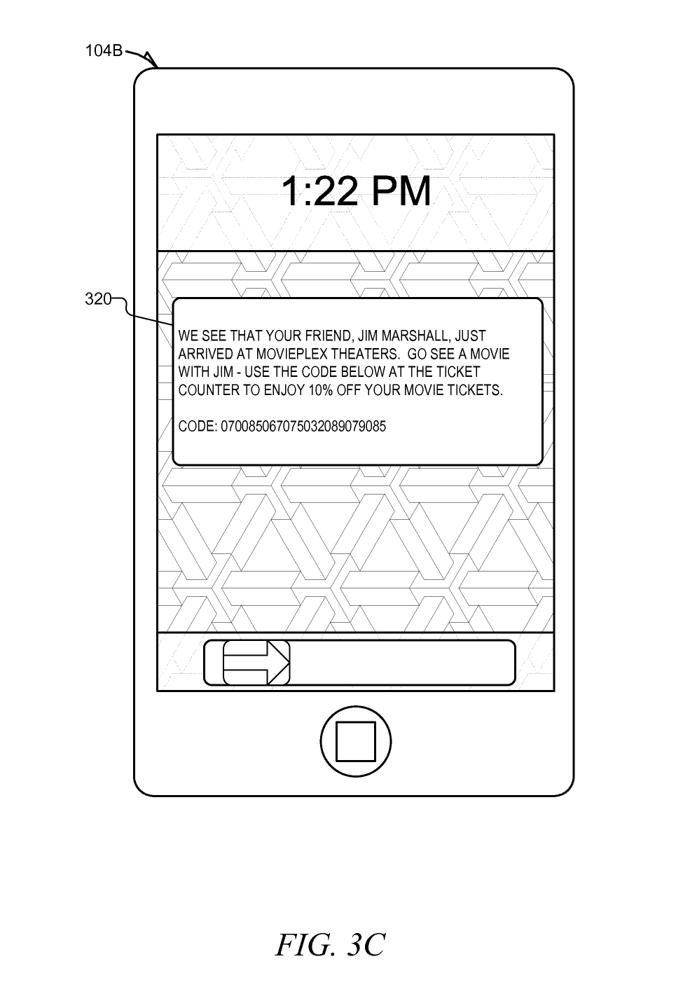

FIG. 3A is a diagrammatic representation of an example geo-fence surrounding a real-world location, consistent with some embodiments. In particular, FIG. 3A illustrates a map view 300 including a geo-fence 302 assigned to the subject user 110 and surrounding a real-world location 304. Consistent with some embodiments, the geo-fence 302 may be assigned to the subject user 110 in response to a request from the subject user 110 or based on the interactions of the subject user 110 with the network-based content publisher 102 or third party application 120 such as a social networking service (e.g., Facebook®). As illustrated in FIG. 3A, the subject user 110 is outside of the perimeter of the geo-fence 302 and in motion towards the geo-fence 302. The client device 104A may be carried by the subject user 110 while in motion towards the geo-fence 302. A mobile location enabled application may be executing on the client device 104A to constantly or periodically provide the location of the subject user 110 to the application server 126.

Returning to FIG. 2, the subject user 110, with the client device 104A in hand (or otherwise on the person of the user), may enter the geo-fence 302. Using the location information provided by the client device 104A, the application server 126 may determine that the subject user 110 has entered the geo-fence 302. In response to detecting the subject user 110 entering the geo-fence 302, the application server 126 may, in an attempt to locate other users of the network-based content publisher 102 that are proximate to the subject user 110, obtain location information from a plurality of other client devices, among which is the client device 104B. Based on the location information obtained from the plurality of other client devices, particularly the client device 104B, the application server 126 may determine that the client device 104B (e.g., a “second device”) is proximate (e.g., within a predefined distance) to the client device 104A (e.g., “the first device”).

FIG. 3B is a diagrammatic representation of the subject user 110 entering the example geo-fence 302 and a plurality of proximate users, consistent with some embodiments. As illustrated in FIG. 3B, the subject user 110 has entered the geo-fence 302. As discussed above, in response to determining that the subject user 110 has entered the geo-fence 302, the application server 126 may locate a plurality of proximate users (e.g., users within a predefined distance of the subject user 110) including the peer user 112 and the users 306 and 308. As with the client device 104A, the client devices being operated by the peer user 112 (e.g., the client device 104B) and the users 306 and 308, may be in constant communication with the application server 126, and in conjunction with one or more applications 116 executing on such client devices, may transmit location information to the application server 126 so as to give the application server 126 a near constant awareness of each users' location.

Returning back to FIG. 2, the application server 126 may determine that the peer user 112 is a peer of the subject user 110. Such determination may be based on social data obtained from third party server 106 hosting a social network service, or based on user data maintained by the network-based content publisher 102. For example, the application server 126 may determine that the peer user 112 is a peer of the subject user 110 based on the two users being connected on one or more social networks. In another example, the application server 126 may determine that the peer user 112 is a peer of the subject user 110 based on the two users have listed similar interests in respectively corresponding social network profiles. In yet another example, the application server 126 may determine that the peer user 112 is a peer of the subject user 110 based on the two users having purchased the same or similar products using marketplace services provided by the network-based content publisher 102.

Upon determining that the peer user 112 is a peer of the subject user 110 and is proximate to the subject user 110, the application server 126 may transmit one or more messages (e.g., push notifications, SMS messages, emails) to the client device 104B being operated by the peer user 112. In addition, in response to the subject user 110 entering the geo-fence 302, the application server 126 may transmit an additional message to the client device 104A operated by the subject user 110.

FIG. 3C is an interface diagram depicting a message presented on a client device of a user, consistent with some embodiments. In particular, FIG. 3C illustrates a notification 320 displayed on the client device 104B of the peer user 112. The notification 320 may be transmitted to the client device 104B as a result of the subject user 110 entering the geo-fence 302. The notification 320 may indicate that the subject user 110 is at least near the real-world location 304. The notification 320 may further include one or more coupons, rewards, or other incentives related to the real-world location 304. Specifically, the notification 320 includes, for example, a unique coupon code that may be redeemed by the peer user 112 at the real-world location 304.

It shall be appreciated that the message transmitted to the client device 104A of the subject user 110 may be similar in form and content to the notification 320. Further, it should be appreciated that the content of the notification 320 in FIG. 3C is presented for illustrative purposes only, and in other embodiments, such notifications may include a myriad of varied coupons, rewards, or other incentives that may be applicable at a real-world location 304, or may be applicable at an electronic marketplace hosted by the application servers 126 or third party server 106. Further, in some embodiments, the particular varied coupons, rewards, or other incentives provided to the subject user 110 or the peer user 112 may be specifically tailored for the user based on the respective preferences of the subject user 110 or the peer user 112 and other information about the subject user 110 or the peer user 112 maintained as part of a user profile. Also, although FIG. 3C illustrates a message being delivered by via an applicable push notification service, the particular communication means is, of course, not limited to such a delivery platform, and may in other embodiments utilize any one of a number of message delivery networks and platforms to deliver messages to the client devices 104A and 104B.

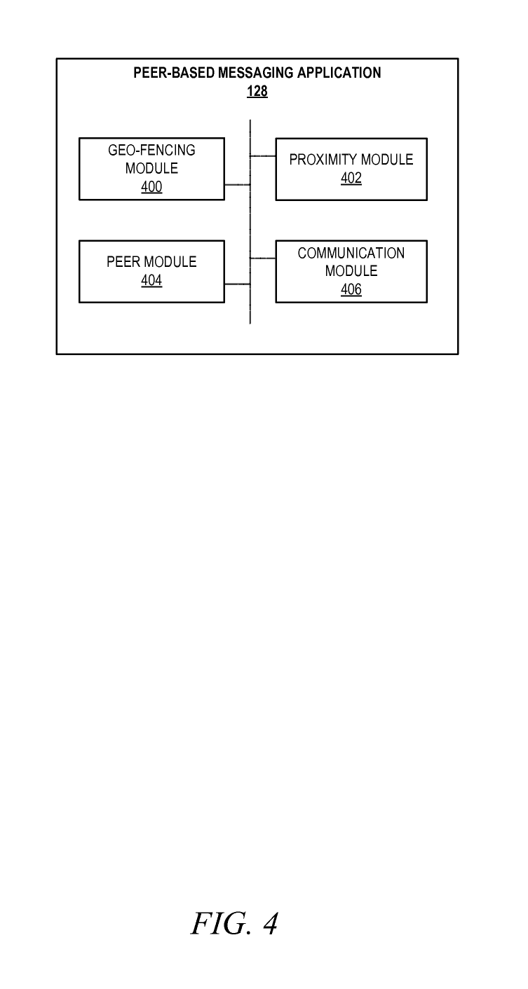

FIG. 4 is a block diagram illustrating an example embodiment of multiple modules forming the peer-based messaging application 128, which is provided as part of the network system 100 of FIG. 1. The peer-based messaging application 128 is shown as including a geo-fencing module 400, a proximity module 402, an peer module 404, and a communication module 406, all configured to communicate with each other (e.g., via a bus, shared memory, a switch, or application programming interfaces (APIs)). The various modules of the peer-based messaging application 128 may access one or more databases 132 via the database servers 130. The modules of the peer-based messaging application 128 may be hosted on dedicated or shared server machines that are communicatively coupled to enable communications between server machines. Further, while the modules 400-406 are discussed in the singular sense, it will be appreciated that in other embodiments multiple instances of the modules 400-406 may be employed.

The geo-fencing module 400 is responsible for generating and provisioning geo-fences to users of the network-based content publisher 102. In some embodiments, the geo-fencing module 400 may generate and assign a geo-fence to a particular user in response to a request for such made by the particular user. In some other embodiments, the geo-fencing module 400 may generate a personalized geo-fence for a user in response to the user conveying an affinity for a particular concept. The generation and provisioning of personalized geo-fences is described in U.S. patent application Ser. No. 14/092,827, entitled “SYSTEM AND METHODS FOR GENERATING AND PROVISIONING A PERSONALIZED GEO-FENCE”, which is hereby incorporated by reference in its entirety.

Each geo-fence generated by the geo-fencing module 400 may be stored in a database (e.g., database 132) and may be maintained as part of the user profile of the user for which the geo-fence has been assigned. The geo-fence is a virtual perimeter surrounding a real-world location (e.g., a physical location or building). In some embodiments, the virtual perimeter may correspond to the actual perimeter of the real-world location. In other embodiments, the virtual perimeter may be generated to be more expansive than simply the perimeter of the real-world location by creating a radius around the real-world location such that parking lots, driveways, entrance gates, sidewalks or other features of the real-world location may be included within the personalized geo-fence. The virtual perimeter defining the personalized geo-fence may also be expanded so as to include various modes of ingress to the real-world location. In some embodiments, the size of a geo-fence may be expanded based on the number of users who have entered the geo-fence.

The geo-fencing module 400 may also be configured to use location information received from a location aware device (e.g., client device 104A and 104B) of the subject user 110 to detect when the subject user 110 has entered or exited the virtual perimeter of a geo-fence. The entering or exiting of the subject user 110 into or out of a geo-fence (also referred to as “breaking,” “breaking in”, “breaking out” or “breaching” a geo-fence) may trigger the communication of a message (e.g., a notification) to the client device 104A of the subject user 110 as well as triggering one or more messages to a client device (e.g., client device 104B) of one or more proximate peer users (e.g., peer user 112) of the subject user 110.

The proximity module 402 may be configured to locate users who are proximate to the subject user 110 upon the subject user 110 breaking in or breaking out of the geo-fence. To this end, the proximity module 402 may locate users of the network-based content publisher 102 that are known to be within a predefined distance of the subject user 110. In some embodiments, the predefined distance may be set by users upon opting into a peer-based notification service, such as subject of the present disclosure.

Users of the network-based content publisher 102 may be operating client devices (e.g., client device 104A or 104B) that may be operating location aware applications (e.g., applications 116) designed to exchange data and interact with the various services of network-based content publisher 102. Such client devices may be in communication with the application server 126 to provide the location of each operating user on a periodic or constant basis. Further, users of such devices may also “check-in” to a location using a mobile application provided by an applicable social network service. The application server 126 may cause such location information (e.g., location information provided directly to the application server 126 and location information corresponding to a “check-in”) to be stored in the database 132 as part of a user account or user profile corresponding to each user. Upon detection of a subject user 110 entering a geo-fence by the geo-fencing module 400, the proximity module 402 may query the database 132 to locate users that are within a predefined distance of the subject user 110 based on the location information stored therein, consistent with some embodiments. In some other embodiments, the proximity module 402 may, upon detecting the subject user 110 entering a geo-fence, scan social media and identify proximate users based on “check-ins” performed by such users at real-world locations that are within the predefined distance of the subject user 110.

The peer module 404 may be configured to identify peer users of a subject user 110. The peer users identified by the peer module 404 may be a subset of the proximate users located by the proximity module 402. In some embodiments, the determination that a user is a peer to the subject user 110 may be based on a commonality in the social data of the subject user 110 and the identified peer. For example, the peer module 404 may identify the peer user 112 as a peer of the subject user 110 based on the two users being connected on a social network.

In some embodiments, the determination that a user is a peer to the subject user 110 may be based on a commonality in the social network activity, which is part of the social data of the two users. To this end, the peer module 404 may retrieve social network activity of users from one or more social networks services. The peer module 404 may obtain social network activities via publically accessible APIs provided by the applicable social network service. In some embodiments, the peer module 404 may obtain social network activities of users of the network-based content publisher 102, and maintain social network activity as part of the user data comprising each of the respective user's profiles, which are stored in databases 132.

For purposes of the present disclosure, “social network activity” collectively refers to one or more social actions performed by a member of a social network using a social network service. Social actions may be published as one or more social network entries (e.g., text and image posts, links, messages, notes, invitations, etc.) that may be shared by members of social networks. Such social network activities may include entries that are intended for the public at large as well as entries intended for a particular social network connection or group of social network connections. Depending on the social network service being used, the social network activity may include, for example, social actions such as a status update, a comment, a tweet, a pin, a like, a favorite, an up-vote, a+1, a share, an activity feed post, a wall post, or a check-in. Consistent with some embodiments, social actions may also include a life change status of a user such as change of relationship status from single to engaged, or from engaged to married, a pregnancy, a birth of a child, or the like. The peer module 404 may determine that two users are peers based on both users performing similar social actions using one or more social network services, consistent with some embodiments. For example, the peer module 404 may determine that two users are peers based on both users changing their respective relationship statuses to “engaged”.

In some embodiments, the peer module 404 may determine that a user is a peer to a subject user 110 based on both users having conveyed an affinity for a particular concept. To this end, the peer module 404 may retrieve and analyze social network activity to identify concepts (e.g., products, brands, merchants, content, etc.) for which users have conveyed an affinity. The peer module 404 may analyze social network entries to identify certain social actions or keywords that may be indicative of an affinity for a particular concept. For example, the peer module 404 may determine that a user has an affinity for a particular brand based on the user having “liked” that brand on Facebook®. In another example, the peer module 404 may determine that a user has an affinity for “sushi” based on the user having repeatedly checked-in at multiple sushi restaurants within a certain time period. In yet another example, the peer module 404 may determine that a user has an affinity for a particular band based on the user having played songs by that band using a socially enabled streaming music service (e.g., Spotify).

In some embodiments, the peer module 404 may determine that a user is a peer of the subject user 110 based on a commonality in the respective transaction histories of each user. For example, the peer module 404 may determine that the peer user 112 is a peer to the subject user 110 based on both users having purchased the same product. In some embodiments, the peer module 404 may determine that a user is a peer of the subject user 110 based on the transaction history of the user including a purchase of an item from a retailer for which a geo-fence has been broken by the subject user 110.

The communication module 406 may be used for generation and delivery of messages to users of the network-based content publisher 102. Such messages may include a notification that a subject user 110 is within a certain distance of a real-world location (e.g., the subject user 110 has entered a geo-fence 302). Further, such messages may include coupons, rewards, or other incentives and may be customized according to information about users maintained as part of each user's respective user profile. Respective communication modules 406 may utilize any one of a number of message delivery networks and platforms to deliver messages to users. For example, the communication module 406 may deliver push notifications (e.g., via a pertinent push notification service), electronic mail (e-mail), instant message (IM), short message service (SMS), text, facsimile, or voice (e.g., voice over IP (VoIP)) messages via a wired network (e.g., the Internet), plain old telephone service (POTS), or wireless (e.g., mobile, cellular, WiFi, WiMAX) networks.

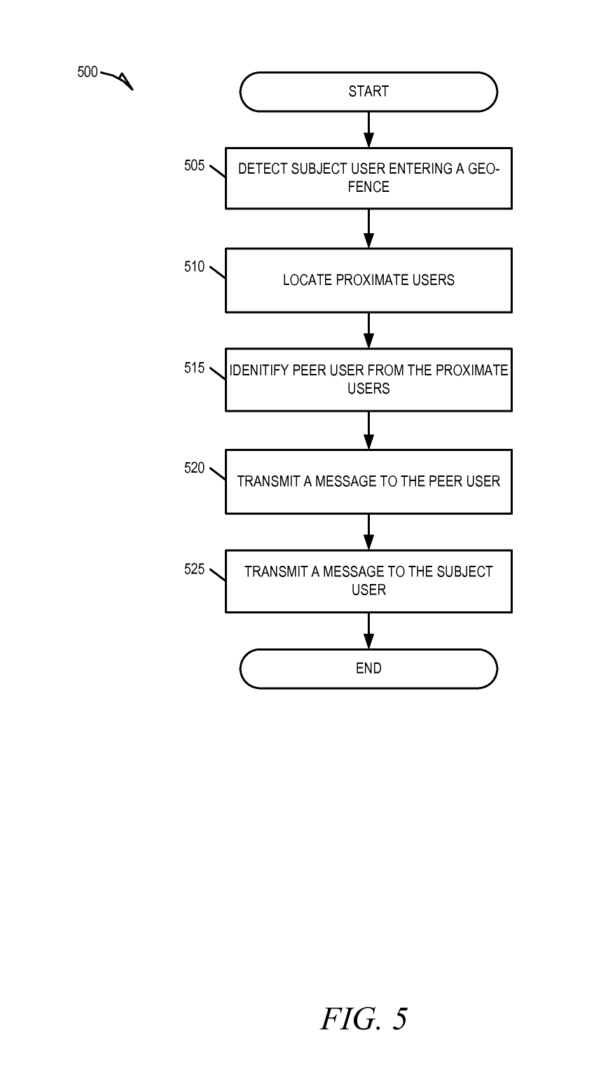

FIG. 5 is a flowchart illustrating an example method 500 for provisioning a peer-based geo-fence message, consistent with some embodiments. The method 500 may be embodied in computer-readable instructions for execution by one or more processors such that the steps of the method 500 may be performed by the application server 126 and, in particular, the modules 400-406 comprising the peer-based messaging application 128.

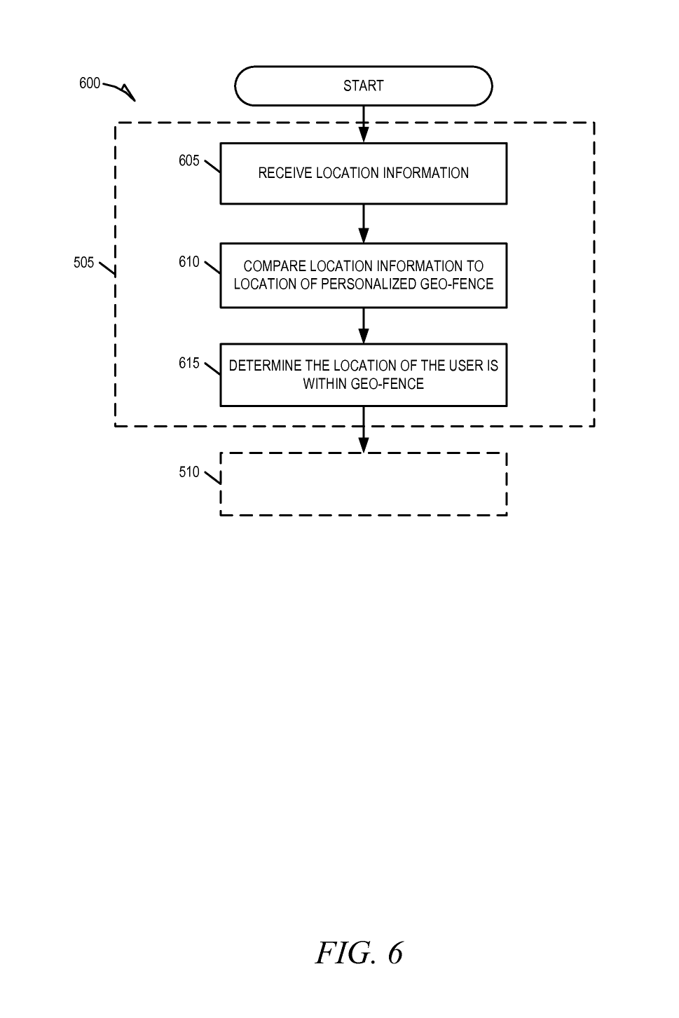

At operation 505, the geo-fencing module 400 may detect the subject user 110 entering or exiting a geo-fence (e.g., geo-fence 302) assigned to the subject user 110. The detecting of the subject user 110 entering or exiting the geo-fence may be based on information received from the location aware client device 104A being carried by the subject user 110. Further details of operation 505 are discussed below in reference to FIG. 6.

At operation 510, the proximity module 402 may identify a plurality of proximate users to the subject user 110 (e.g., users within a predefined distance of the subject user 110). Consistent with some embodiments, the proximity module 402 may access records that include location information for each user (e.g., information providing the real-world location of the users) of the network-based content publisher 102 from the database 132. The proximity module 402 may query the database 132 to identify all users that are within the predefined distance of the subject user 110. In some other embodiments, the proximity module 402 may access social network activity, specifically check-ins, of the users of the network-based content publisher 102 to locate proximate users.

At operation 515, the peer module 404 may identify a peer user 112 of the subject user 110 from the plurality of proximate users. The peer module 404 may determine that the peer user 112 is a peer of the subject user 110 based on social data about the two users retrieved from one or more social networks, or from a transaction history maintained as part of a user profile of each user maintained by the network-based content publisher 102. For example, the peer module 404 may determine that the peer user 112 is a peer of the subject user 110 based on the subject user 110 and the peer user 112 being “friends” on Facebook®. In another example, the peer module 404 may determine the peer user 112 is a peer of the subject user 110 based on the social data about subject user 110 and the peer user 112 indicating that both users are fans of the Los Angeles Lakers®. In yet another example, the subject user 110 has broken a geo-fence corresponding to Best Buy®, and the peer module 404 may determine that the peer user 112 is a peer of the subject user 110 based on the transaction history of the peer user 112 including multiple purchases from Best Buy®.

At operation 520, the communication module 406 may transmit a message to the client device 104B of the peer user 112. Although the operations 510 and 515 are intermediary steps to identify the peer user 112, the message is transmitted to the client device 104B of the peer user 112 in response to the subject user 110 breaching the geo-fence. Similarly, an additional message may be transmitted by the communication module 406 to the client device 104A of the subject user 110 in response to the subject user 110 having entered the geo-fence in operation 525. Such messages may, for example, include an indication that the subject user 110 has entered the geo-fence, and may further include a coupon, reward, or other incentive. The coupons, rewards, and other incentives included therein may be related to the real-world location for corresponding to the geo-fence broken by the subject user 110.

FIG. 6 is a flowchart illustrating an example method 600 for detecting a user entering a geo-fence, consistent with some embodiments. In some embodiments, the method 600 may correspond to operation 505. The method 600 may be embodied in computer-readable instructions for execution by one or more processors such that the steps of the method 600 may be performed by the application server 126, and in particular, the geo-fencing module 400.

At operation 605, location information may be received by the geo-fencing module 400 from the location aware client device 104A of the subject user 110. The location information includes the real-world location of the client device 104A, which is assumed to correspond to the location of the subject user 110. The location information may be transmitted to the application server 126 by a mobile location enabled application executing on the client device 104A. Such information may be constantly, or periodically, provided to the application server 126.

At operation 610, the geo-fence module 400 compares the location information received at operation 605 with the location of the geo-fence. At operation 615, if the location of the subject user 110 (e.g., the location of the client device 104A) is within the virtual perimeter defining the geo-fence, the subject user 110 may be determined to have entered the geo-fence.

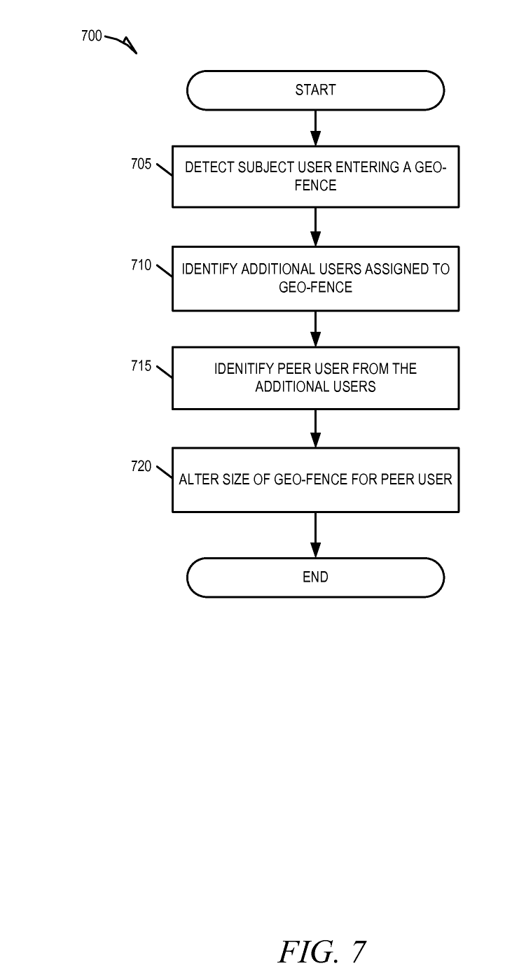

FIG. 7 is a flowchart illustrating an example method 700 for expanding a size of a geo-fence of a peer user 112, consistent with some embodiments. The method 700 may be embodied in computer-readable instructions for execution by one or more processors such that the steps of the method 700 may be performed by the application server 126 and, in particular, the modules 400-406 comprising the peer-based messaging application 128.

At operation 705, the geo-fencing module 400 may detect the subject user 110 breaching a geo-fence (e.g., geo-fence 302). The detecting of the subject user 110 breaching the geo-fence may be based on information received from the client device 104A being operated by the subject user 110. It shall be appreciated that the operations comprising method 700 are applicable in instances in which the geo-fence breached by the subject user 110 is assigned to the subject user 110 as well as instances in which the subject user 110 is not assigned to or otherwise associated with said geo-fence.

At operation 710, the geo-fencing module 400 may identify a plurality of additional users assigned to the geo-fence. The geo-fencing module 400 may obtain information regarding the assignment of geo-fences from user data maintained as part of user profiles and stored in the database 132, consistent with some embodiments. At operation 715, the peer module 404 may identify the peer user 112 from the plurality of additional users as a peer to the subject user 110. In some embodiments, the identification of the peer user 112 as a peer of the subject user 110 may be based on social data about the users that is retrieved from one or more social network services.

At operation 720, the geo-fencing module 400 may alter the size of the geo-fence in response to the subject user 110 having breached the geo-fence. In some embodiments, the size of the geo-fence is altered for each of the plurality of additional users that are assigned to the geo-fence. In some other embodiments, the size of the geo-fence is altered only for the purposes of the peer user 112. Altering the size of the geo-fence may, for example, include increasing or decreasing an area covered by the geo-fence, increasing or decreasing a radius of the geo-fence (e.g., for situations in which the virtual perimeter is circular or semi-circular), extending outer bounds of the geo-fence, adding or removing sections of the geo-fence, or modifying the size of the geo-fence so as to include an additional real-world location inside the virtual perimeter. Once the altered geo-fence is entered by a user assigned to the geo-fence, a communication may be transmitted to at least that user.

### Module, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application 116 or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a FPGA or an ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware module at different times. Software may accordingly configure a processor, for example, to constitute a particular hardware module at one instance of time and to constitute a different hardware module at a different instance of time.

A hardware module can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented module that operate to perform one or more operations or functions. The module referred to herein may, in some example embodiments, comprise processor-implemented module.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network 108 (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site, or distributed across multiple sites and interconnected by a communication network 108.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network 108. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

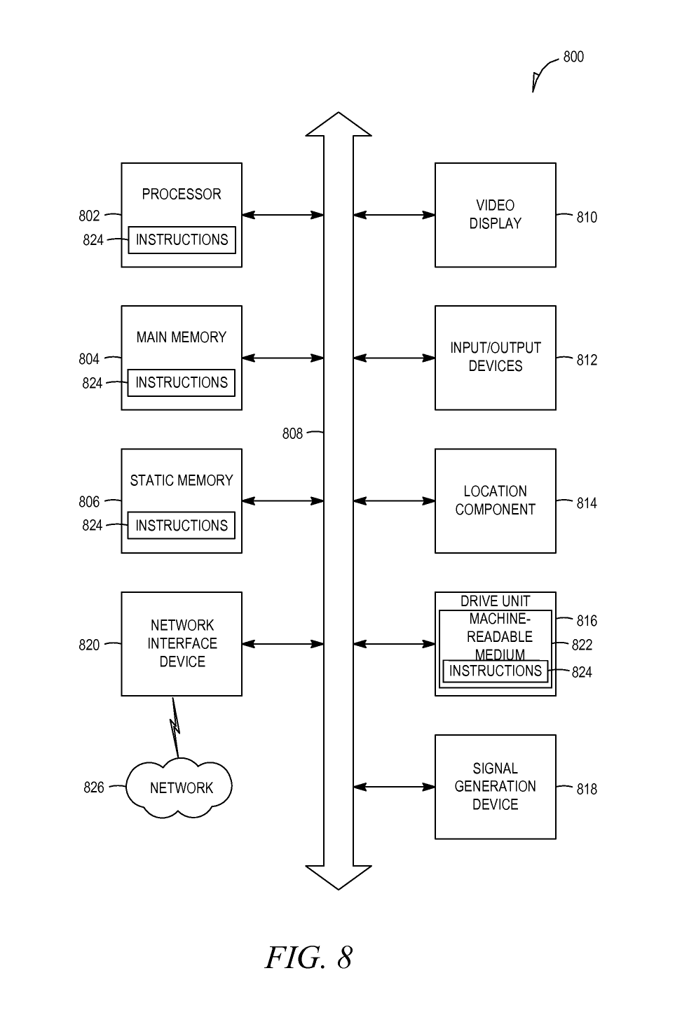

FIG. 8 is a diagrammatic representation of a machine in the example form of a computer system 800 within which a set of instructions for causing the machine to perform any one or more of the methodologies discussed herein may be executed. The computer system 800 may correspond to client device 104A or 104, third party server 106, or application server 126, consistent with some embodiments. The computer system 800 may include instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a STB, a PDA, a cellular telephone, a smart phone (e.g., iPhone®), a tablet computer, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes one or more input/output (I/O) devices 812, a location component 814, a drive unit 816, a signal generation device 818 (e.g., a speaker), and a network interface device 820. The I/O devices 812 may, for example, include a keyboard, a mouse, a keypad, a multi-touch surface (e.g., a touchscreen or track pad), a microphone, a camera, and the like.

The location component 814 may be used for determining a location of the computer system 800. In some embodiments, the location component 814 may correspond to a GPS transceiver that may make use of the network interface device 820 to communicate GPS signals with a GPS satellite. The location component 814 may also be configured to determine a location of the computer system 800 by using an internet protocol (IP) address lookup or by triangulating a position based on nearby mobile communications towers. The location component 814 may be further configured to store a user-defined location in main memory 804 or static memory 806. In some embodiments, a mobile location enabled application may work in conjunction with the location component 814 and the network interface device 820 to transmit the location of the computer system 800 to an application server 126 or third party server 106 for the purpose of identifying the location of a user operating the computer system 800.

In some embodiments, the network interface device 820 may correspond to a transceiver and antenna. The transceiver may be configured to both transmit and receive cellular network signals, wireless data signals, or other types of signals via the antenna, depending on the nature of the computer system 800.

### Machine-Readable Medium

The drive unit 816 includes a machine-readable medium 822 on which is stored one or more sets of data structures and instructions 824 (e.g., software) embodying or used by any one or more of the methodologies or functions described herein. The instructions 824 may also reside, completely or at least partially, within the main memory 804, static memory 806, and/or within the processor 802 during execution thereof by the computer system 800, with the main memory 804 and the processor 802 also constituting machine-readable media.

Consistent with some embodiments, the instructions 824 may relate to the operations of an operating system (OS). Depending on the particular type of the computer system 800, the OS may, for example, be the iOS® operating system, the Android® operating system, a BlackBerry® operating system, the Microsoft® Windows® Phone operating system, Symbian® OS, or webOS®. Further, the instructions 824 may relate to operations performed by applications 116 (commonly known as “apps”), consistent with some embodiments. One example of such an application 116 is a mobile browser application that displays content, such as a web page or a user interface using a browser.

While the machine-readable medium 822 is shown, in an example embodiment, to be a single medium, the term “machine-readable medium” may include a single medium or multiple media (e.g., a centralized or distributed database, and/or associated caches and servers) that store the one or more data structures or instructions 824. The term “machine-readable medium” shall also be taken to include any tangible medium that is capable of storing, encoding, or carrying instructions (e.g., instructions 824) for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one real-world location to another. Additionally, since the machine-readable medium is tangible, the medium may be considered to be a machine-readable device.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium that is capable of storing, encoding, or carrying instructions 824 for execution by the machine, and includes digital or analog communications signals or other intangible media to facilitate communication of such software.

Although the embodiments of the present invention have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

What is claimed:

1. A system comprising:
a processor of a machine;
a geo-fencing module to detect a subject user breaching a geo-fence, the geo-fence being a virtual perimeter surrounding a physical location;
a proximity module to locate a plurality of proximate users within a predefined distanced of the subject user;
an peer module to identify, using the processor of the machine, a peer user of the subject user from the plurality of proximate users; and
a communication module to transmit a message to a client device of the peer user in response to the subject user breaching the geo-fence.

2. The system of claim 1, wherein the geo-fencing module detects the user breaching the virtual perimeter by:
receiving geo-location information from a client device of the subject user indicating a location of the subject user;
comparing the location of the subject user with a location of the virtual perimeter; and
determining the location of the subject user is within the virtual perimeter.

3. The system of claim 1, wherein the proximity module locates the plurality of proximate users within the predefined distance of the subject user based on location information received from a mobile application executing on client devices that correspond to each of the plurality of proximate users.

4. The system of claim 1, wherein the peer user of the subject user is identified based on transactional data about marketplace transactions made by the subject user and the peer user.

5. The system of claim 1, wherein the peer user of the subject user is identified based on the peer user and the subject being part of a demographic group.

6. The system of claim 1, wherein the peer module identifies the peer user of the subject user by:
identifying, from social data about the subject user, a concept for which the subject user has conveyed an affinity; and
determining the peer user has conveyed an affinity for the concept based on social data about the peer user.

7. The system of claim 6, wherein the determining the subject user and the peer user have conveyed the affinity for the concept comprises determining that the subject user and peer user have performed at least one of the following social network actions with respect to the concept: a like, a favorite, an up-vote, a+1, a share, or a post referencing the concept.

8. The system of claim 1, wherein the message is a push notification.

9. A method comprising:
detecting a subject user breaching a geo-fence, the geo-fence being a virtual perimeter surrounding a physical location;
locating a plurality of proximate users within a predefined distance of the subject user;
identifying, using a processor of a machine, a peer user of the subject user from the plurality of proximate users; and
in response to the subject user breaching the geo-fence, transmitting a message to a client device of the peer user.

10. The method of claim 9, wherein the detecting the subject user breaching the virtual perimeter comprises:
receiving geo-location information from a client device being operated by the subject user, the geo-location information identifying a location of the subject user;
comparing the location of the subject user with a location of the virtual perimeter; and
determining that the location of the subject user is within the virtual perimeter.

11. The method of claim 9, wherein the locating the plurality of proximate users within the predefined distance of the subject user is based on geo-location information received from a mobile application executing on a client device corresponding to each of the plurality of proximate users.

12. The method of claim 9, wherein the identifying of the peer users of the subject user is based on social data of the plurality of proximate users.

13. The method of claim 12, wherein the social data of the plurality of proximate users include at least one interest of each of the plurality of proximate users, and wherein the subject user and the peer user share the at least one interest.

14. The method of claim 9, wherein the peer user is a social network connection of the subject user.

15. The method of claim 9, wherein the identifying the peer user of the subject user comprises:
identifying a product purchased by the subject user based on a transaction history of the subject user; and
determining that the peer user purchased the product.

16. The method of claim 9, further comprising transmitting an additional message to the subject user in response to the subject user breaching the geo-fence.

17. The method of claim 16, wherein the message indicates that the subject user has breached the personalized geo-fence.

18. The method of claim 9, wherein the message includes a coupon.

19. The method of claim 9, wherein the predefined distance is specified by the peer user.

20. A non-transitory machine-readable storage medium embodying instructions that, when executed by a machine, cause the machine to perform operations comprising:
detecting a subject user breaching a geo-fence, the geo-fence being a virtual perimeter surrounding a physical location;
locating a plurality of proximate users within a predefined distance of the subject user;
identifying a peer user of the subject user from the plurality of proximate users; and
in response to the subject user breaching the geo-fence, transmitting a message to a client device of the peer user.
